(19) United States
(12) Patent Application Publication
(10) Pub. No.: US 2004/0242263 A1
(43) Pub. Date: Dec. 2, 2004

(54) Portable telephone apparatus

(76) Inventors: Yukio Nishimoto, Tottori-shi (JP); Eiji Kanzaki, Tottori-shi (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/495,745

(22) PCT Filed: Feb. 24, 2003
(86) PCT No.: PCT/JP03/02012

(30) Foreign Application Priority Data
May 15, 2002 (JP) 2002-140382

(51) Int. Cl. H04M 1/00

(52) U.S. Cl. 455/550.1; 455/556.1

(57) ABSTRACT

A portable telephone comprising a CCD camera (8) for photographing an object, a sub-LCD (9), a memory (not shown) for storing information required for photographing, and a control means (not shown) for controlling the sub-LCD (9) to display the information required for photographing when the CCD camera (8) photographs the object, wherein the CCD camera (8) and the sub-LCD (9) are arranged on the same side of the case (1) so that display of the sub-LCD (9) can be confirmed visually from the photographing range of the CCD camera (8) even under a state where the case (1) and a case (2) are folded by 90°.

### TECHNICAL FIELD

The present invention relates to a portable telephone apparatus, and more particularly to a portable telephone apparatus provided with a camera.

### BACKGROUND ART

In recent years, portable telephone apparatuses provided with a camera have been widespread. Portable telephone apparatuses provided with a camera typically have a self-timer capability. An example of the outer appearance of a conventional portable telephone apparatus provided with a camera and having a self-timer capability is shown in FIGS. 5A and 5B. FIG. 5A is a front perspective view, and FIG. 5B is a rear perspective view.

The portable telephone apparatus 500 provided with a camera has casings 501 and 502 that pivot on a hinge 503 so that they can be folded together. A loudspeaker 504 and a main LCD (liquid crystal display) 505 are provided on the front face of the casing 501, and a key entry portion 506 and a microphone 507 are provided on the front face of the casing 502.

On the back face of the casing 501, there is provided a sub LCD 509 that notifies the user about the antenna condition, battery level, incoming calls, etc. when the casings 501 and 502 are folded together. On the back face of the casing 502, there are provided an image capture lens 5081 of a CCD (charge-coupled device) camera 508, an antenna 510, and an indicator LED (light-emitting diode) 511. The indicator LED 511 is so located as to be visually recognizable from the subject (person) of the CCD camera 508.

When the user selects a self-timer mode through key operation, an internal timer starts to operate, and the indicator LED 511 starts to blink. Thereafter, as time passes, the indicator LED 511 blinks at increasingly short intervals. When a predetermined period of time has elapsed, a still picture is taken automatically. On completion of the shot, the indicator LED 511 goes out.

In this way, by varying the time intervals at which the indicator LED 511 is made to blink, it is possible to let the subject (person) know when the shutter will be released. Some models of portable telephone apparatuses use sound to let the subject (person) know when the shutter will be released in the self-timer mode.

With these conventional portable telephone apparatuses, however, indication using light or sound may let the subject (person) roughly know when the shutter will be released in the self-timer mode, but not precisely. Moreover, indication using light or sound can give the subject (person) only relatively simple information, such as when the shutter will be released.

### DISCLOSURE OF THE INVENTION

An object of the present invention is to provide a portable telephone apparatus provided with a camera which can give the subject of the camera more detailed information when he is shot with it. Another object of the present invention is to provide a program that permits a portable telephone apparatus provided with a camera to give the subject of the camera more detailed information when he is shot with it.

To achieve the above objects, according to the present invention, a portable telephone apparatus is provided with a camera for shooting a subject, a display, a memory for storing information necessary for shooting, and a controller for making the information necessary for shooting displayed on the display when the camera shoots the subject. Here, the information necessary for shooting displayed on the display can be visually recognized from within the shooting range of the camera.

According to the present invention, in the portable telephone apparatus constructed as described above, the display may have a first display portion for displaying an image of the subject and a second display portion, provided on the back face of the first display portion, for displaying the information necessary for shooting.

According to the present invention, in the portable telephone apparatus constructed as described above, what is displayed on the second display portion may be displayed also on the first display portion.

According to the present invention, the portable telephone apparatus constructed as described above may be further provided with a shutter button and a detector for detecting a first pressed position and a second pressed position of the shutter button. Here, when the detector detects the first pressed position, the controller makes the display display the information necessary for shooting, and, when the detector detects the second pressed position, the camera shoots the subject.

According to the present invention, in the portable telephone apparatus constructed as described above, the information necessary for shooting may be a message to the subject, or a remaining time of a self-timer, or a focus condition of the camera.

According to the present invention, the portable telephone apparatus constructed as described above may be a portable telephone apparatus of a foldable design which is provided with a camera and which has two casings that can be folded together, with the image capture portion of the camera and the display provided on the same face of the same one of the casings.

### BRIEF DESCRIPTION OF DRAWINGS

FIGS. 1A and 1B are diagrams showing the outer appearance of a portable telephone apparatus according to the invention.

FIG. 2 is a diagram showing the portable telephone apparatus according to the invention, in its state folded at 90 degrees.

FIG. 3 is a circuit block diagram showing the circuit blocks related to the camera capabilities of the portable telephone apparatus according to the invention.

FIG. 4 is a flow chart showing the operation of the CPU shown in FIG. 3 in the camera mode.

FIGS. 5A and 5B are diagrams showing the outer appearance of a conventional portable telephone apparatus provided with a camera and having a self-timer capability.

### BEST MODE FOR CARRYING OUT THE INVENTION

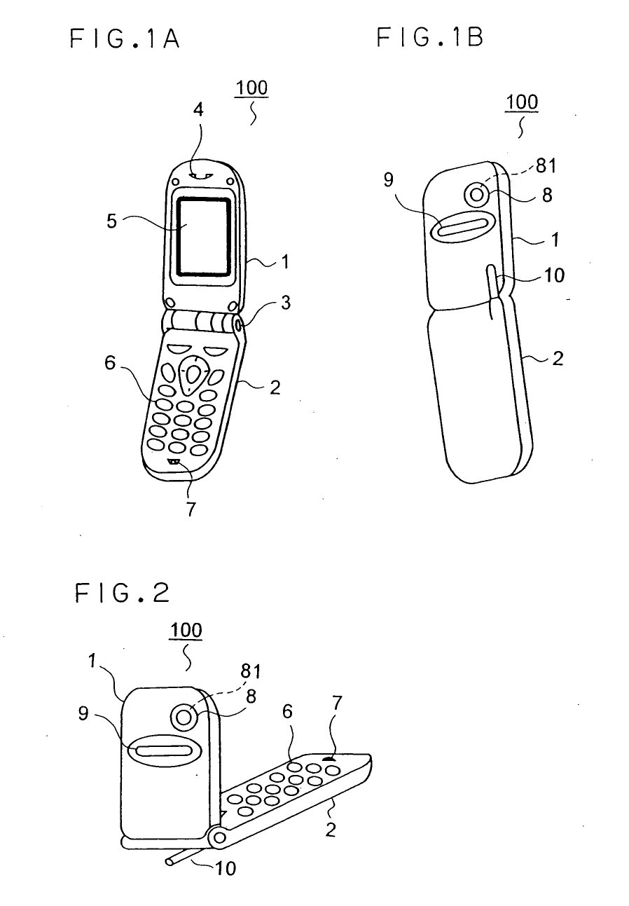

Hereinafter, an embodiment of the present invention will be described with reference to the drawings. An example of the outer appearance of a portable telephone apparatus provided with a camera according to the invention is shown in FIGS. 1A and 1B. FIG. 1A is a front perspective view, and FIG. 1B is a rear perspective view.

The portable telephone apparatus 100 has casings 1 and 2 that pivot on a hinge 3 so that they can be folded together. A loudspeaker 4 and a main LCD 5 are provided on the front face of the casing 1, and a key entry portion 6 and a microphone 7 are provided on the front face of the casing 2. Moreover, an image capture lens 81 of a CCD camera 8 and a sub LCD 9 are provided on the back face of the casing 1, and an antenna 10 is provided on the back face of the casing 2.

In this way, the lens 81 of the CCD camera 8 and the sub LCD 9 are provided on the same face of the casing 1. Thus, even when shooting is performed with the casings 1 and 2 folded at 90 degrees so that the portable telephone apparatus is supported on the back face of its own casing 2 as shown in FIG. 2, the subject (person) can visually recognize what is displayed on the sub LCD 9.

Moreover, since the lens 81 of the CCD camera 8 and the sub LCD 9 are provided on the same face of the casing 1, the sub LCD 9 can be located near the lens 81 of the CCD camera 8. This helps prevent the line of sight of the subject (person) from greatly deviating from the lens 81 of the CCD camera 8 even when he views what is displayed on the sub LCD 9 while being shot. Incidentally, the portable telephone apparatus 100 can be fitted with an external flash unit (not illustrated).

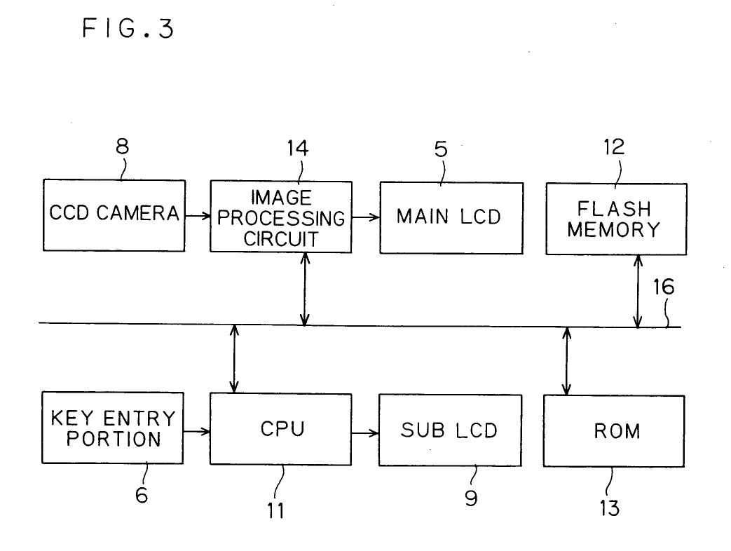

FIG. 3 is a circuit block diagram of the portable telephone apparatus 100. It should be noted that FIG. 3 does not show circuit blocks that are related to the telephone capabilities, because they do not involve any characteristic features of the present invention, and accordingly it should be understood that the portable telephone apparatus 100 quite naturally also includes circuit blocks related to the telephone capabilities, such as an antenna, a wireless unit, a loudspeaker, a microphone, a sound processor, and a sound encoder, etc. In FIG. 3, such components as are found also in FIGS. 1A and 1B are identified with the same reference numerals.

A CPU (central processing unit) 11 is connected to the key entry portion 6 and to the sub LCD 9, and is also connected, by way of a bus 16, to the CCD camera 8 and to a flash memory 12, ROM (read-only memory) 13, and image processing circuit 14. The CCD camera 8 is connected to the image processing circuit 14, and the image processing circuit 14 is connected to the main LCD 5.

According to the output signal of the key entry portion 6 and according to the program stored in the ROM 13, the CPU 11 controls the operation of the CCD camera 8, sub LCD 9, flash memory 12, and image processing circuit 14. The CPU 11 also controls the telephone capabilities, but no description will be given of those aspects of its operation.

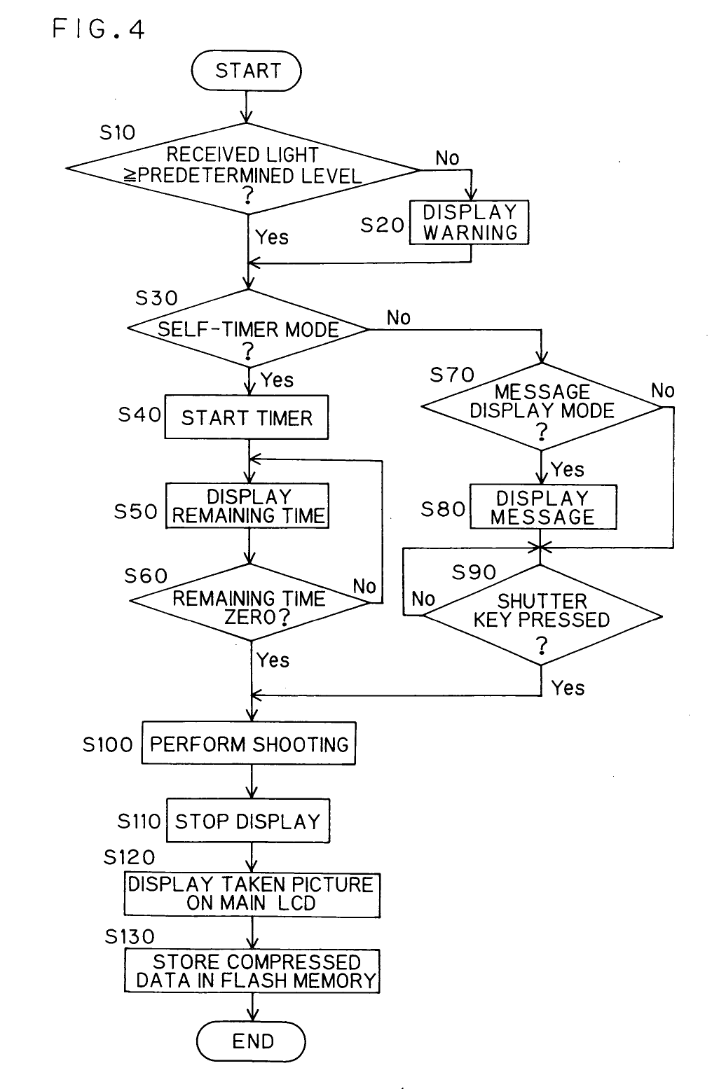

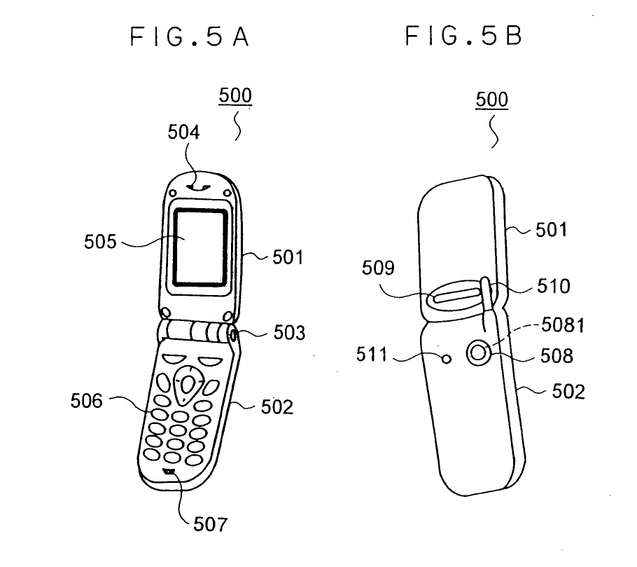

Now, the operation that the portable telephone apparatus 100 performs to achieve shooting will be described with reference to the circuit block diagram shown in FIG. 3 and the flow chart shown in FIG. 4. Prior to shooting, when the user selects a camera mode through key operation, the key entry portion 6 feeds the CPU 11 with a signal informing it that the camera mode is requested.

On receiving the signal from the key entry portion 6 indicating that the camera mode is requested, the CPU 11 starts the CCD camera 8. The CCD camera 8 converts the image captured through the lens 81 into an electrical signal, then amplifies the electrical signal to a predetermined level, and then feeds it to the image processing circuit 14. Incidentally, the CCD camera 8 determines the gain at which it amplifies the electrical signal so that the electrical signal is amplified to the predetermined level.

The image processing circuit 14 converts the output signal of the CCD camera 8, which is an analog signal, into a digital signal, and then performs predetermined image processing on it to produce an image signal. The image signal is then fed to the main LCD 5. Thus, the main LCD 5 displays the image (moving picture) captured by the CCD camera 8.

Then, in the flow chart shown in FIG. 4, the CPU 11 receives, from the CCD camera 8, information on the amount of light that the CCD camera 8 is receiving to check whether or not the amount of light is larger than a predetermined level (step S10). If the amount of light is larger than the predetermined level (“Yes” in step S10), the flow proceeds to step S30.

On the other hand, if the amount of light is not larger than the predetermined level (“No” in step S10), the CPU 11 reads a warning message, like “Use a flash!,” previously stored in the flash memory 12, and displays it on the sub LCD 9 (step S20). The flow then proceeds to step S30.

In step S30, on the basis of the output signal of the key entry portion 6, the CPU 11 checks whether or not a self-timer mode is requested. When the user selects the self-timer mode through key operation, the key entry portion 6 feeds the CPU 11 with a signal that informs it that the self-timer mode is requested.

If the self-timer mode is requested (“Yes” in step S30), the CPU 11 starts an internal timer (step S40), and calculates the time remaining before shooting to displays it, one second after another, on the sub LCD 9 (step S50). Then, the CPU 11 checks whether or not the time remaining before shooting is zero (step S60) so that, if so, the flow proceeds to step S100 and, if not, the flow proceeds to step S50.

On the other hand, if the self-timer mode is not requested (“No” in step S30), on the basis of the output signal of the key entry portion 6, the CPU 11 checks whether or not a message display mode is requested (step S70). When the user selects the message display mode through key operation, the key entry portion 6 feeds the CPU 11 with a signal that informs it that the message display mode is requested.

If the message display mode is requested (“Yes” in step S70), the CPU 11 reads a message, like “Smile!,” previously stored in the flash memory 12, and displays it on the sub LCD 9 (step S80). The flow then proceeds to step S90.

If the number of characters contained in the message is larger than that which can be displayed on the sub LCD 9, it is advisable to scroll the message on the sub LCD 9. It is preferable to permit the messages previously stored in the flash memory 12 to contain not only JIS (Japanese Industrial Standard) characters but also non-JIS characters, such as symbols and icons.

On the other hand, if the message display mode is not requested (“No” in step S70), the flow proceeds to step S90. In step S90, on the basis of the output signal of the key entry portion 6, the CPU 11 checks whether or not the key defined as a shutter button is pressed. If the key defined as a shutter button is pressed (“Yes” in step S90), the flow proceeds to step S100.

In step S100, under the control of the CPU 11, the CCD camera 8 takes a still picture. In step S110, the CPU 11 stops the display on the sub LCD 9, and then, in step S120, the CPU 11 displays the thus taken still picture on the main LCD 5. Under the control of the CPU 11, the image processing circuit 14 converts the output signal of the CCD camera 8, which is an analog signal, into a digital signal, and then performs predetermined image processing on it to produce an image signal.

The image processing circuit 14 further performs compression processing on the image signal to produce compressed image data. Then, in step S130, under the control of the CPU 11, the compressed image data is stored in the flash memory 12. On completion of step S130, the CPU 11 ends the camera mode.

The shooting range of a camera provided in a portable telephone apparatus is typically about 50 cm. Thus, with the portable telephone apparatus 100 according to the invention, the subject (person) can quite easily recognize the characters displayed on the sub LCD 9 in steps S20, S50, and S80. In this way, the portable telephone apparatus 100 can give the subject (person) detailed information on various things when he is shot with it.

For example, it is possible to display, not only a message at the moment of shooting and the remaining time of the self-timer as described above, but also the focus condition of the subject in step S50. This permits the subject, when out of focus, to move to an in-focus position, and thus helps prevent a failed shot resulting from the subject being too close to the camera.

It is preferable to display the same messages and information, such as the focus condition, not only on the sub LCD 9 but also on the main LCD 5. This permits the photographer to know what is displayed on the sub LCD 9.

In a case where an LED is provided that can be visually recognized from within the shooting range of the CCD camera 8, the LED may be made to blink as the messages and information are displayed on the sub LCD 9 in steps S20, S50, and S80. Sound may be given off as the messages and information are displayed on the sub LCD 9 in steps S20, S50, and S80.

Incidentally, in steps from S70 through S100, a two-step key may be used as the key defined as a shutter button in the key entry portion 6. In that case, when the key is pressed in to the first step, the CCD camera 8 adjusts focus with the aforementioned message displayed on the sub LCD 9, and, when the key is pressed further in to the second step, shooting is performed. This makes it possible to let the subject (person) know that he is about to be shot, and thus permits the subject (person) to pose for a picture.

The embodiment described above deals with a portable telephone apparatus having the lens 81 of a CCD camera 8 and a sub LCD 9 provided on the same face of a casing 1. The present invention, however, is not limited to such a construction. The present invention is applicable, for example, to a portable telephone apparatus having two casings that can be folded together, having a camera provided on the back face of one casing, and having a display provided on the back face of the other casing. Even in that case, the present invention permits what is displayed on the display to be visually recognized from within the shooting range of the camera so long as the two casings are not folded together.

### Industrial Applicability

According to the present invention, a portable telephone apparatus is provided with a camera for shooting a subject, a display, a memory for storing predetermined information, and a controller for making the predetermined information displayed on the display when the camera shoots the subject, and what is displayed on the display can be visually recognized from within the shooting range of the camera. This permits the subject (person) to view the predetermined information, such as a message, displayed on the display when he is shot with the camera.

The shooting range of a camera provided in a portable telephone apparatus is typically about 50 cm. Thus, with the portable telephone apparatus according to the invention, the subject (person) can quite easily recognize the predetermined information, such as a message, displayed on the display. In this way, it is possible to give the subject detailed information when he is shot with the camera.

According to the present invention, the portable telephone apparatus constructed as described above may be built as a portable telephone apparatus of a foldable design which is provided with a camera and which has two casings that can be folded together, with the camera and the display provided on the same face of the same casing. This helps prevent the line of sight of the subject (person) from greatly deviating from the camera even when he views what is displayed on the display while being shot.

With the casings folded halfway (for example to 90 degrees), shooting can be performed with the camera supported on the outer (back) face of the casing other than the one in which the camera and the display are provided.

1. A portable telephone apparatus comprising a camera for shooting a subject, a display, a memory for storing information necessary for shooting, and a controller for making the information necessary for shooting displayed on the display when the camera shoots the subject,
wherein the information necessary for shooting displayed on the display can be visually recognized from within a shooting range of the camera.

2. A portable telephone apparatus as claimed in claim 1,
wherein the display has a first display portion for displaying an image of the subject and a second display portion, provided on a back face of the first display portion, for displaying the information necessary for shooting.

3. A portable telephone apparatus as claimed in claim 2,
wherein what is displayed on the second display portion is displayed also on the first display portion.

4. A portable telephone apparatus as claimed in claim 1, further comprising:
a shutter button and detector for detecting a first pressed position and a second pressed position of the shutter button,
wherein, when the detector detects the first pressed position, the controller makes the display display the information necessary for shooting, and, when the detector detects the second pressed position, the camera shoots the subject.

5. A portable telephone apparatus as claimed in claim 1,
wherein the information necessary for shooting is a message to the subject.

6. A portable telephone apparatus as claimed in claim 1,
wherein the information necessary for shooting is a remaining time of a self-timer.

7. A portable telephone apparatus as claimed in claim 1,
wherein the information necessary for shooting is a focus condition of the camera.

8. A portable telephone apparatus as claimed in claim 1,
wherein the portable telephone apparatus is a portable telephone apparatus of a foldable design which is provided with a camera and which has two casings that can be folded together, and an image capture portion of the camera and the display are provided on a same face of a same one of the casings.
